(19) United States
(12) Patent Application Publication
(10) Pub. No.: US 2010/0024745 A1
(43) Pub. Date: Feb. 4, 2010

(54) Protective pet device

(76) Inventor: John Harlow, Richmond, VA (US)

Correspondence Address: John Harlow, 6707 Glenwood Street, Richmond, VA, 23230, US

(21) Appl. No.: 12/221,535

(22) Filed: Aug. 4, 2008

(51) Int. Cl. A01K 29/00

(52) U.S. Cl. 119/856; 119/850

(57) ABSTRACT

According to certain preferred embodiments of the present invention, protective devices configured to be located around the neck region of a pet are provided, which are capable of preventing the pet from biting, licking, or otherwise irritating a wound located on the body of the pet. According to certain embodiments, device has five contiguously connected sides, a first open end and a second open end. The first open end is located around the pet's head and exhibits a pentagon-shaped peripheral edge, whereas the second open end is located around the pet's neck and comprises a circular (or oval) shaped peripheral edge. Preferably, the device will be comprised of a clear, or substantially clear, plastic material, such that the pet's peripheral vision is not impeded during use of the device.

### FIELD OF THE INVENTION

The field of the present invention relates to protective devices for pets, which are designed to be worn around the head and neck of the pet to prevent the pet from biting, licking, or otherwise irritating a wound located on its body.

### BACKGROUND OF THE INVENTION

Protective cones have been worn and used by pets for many years. Most pet owners will recognize the familiar cone (or lampshade) object that pets will be required to wear, in order to prevent the pet from biting, licking or otherwise irritating a wound located on its body. While these so-called protective cones are effective in preventing the pet from twisting its neck and body and disturbing a wound, the cones suffer from many drawbacks.

First, the prior art protective cones are unwieldy in size and configuration. The large, conical cross-section of such devices often causes pets to “bump into” furniture or even breakable items that may be located throughout a household. In addition, because the cones are typically comprised of a non-transparent material, the cones significantly diminish the peripheral vision of the pet. This will often aggravate the pet—and further make navigating a household (without “bumping into” furniture or breakable items) more difficult for the pet.

Accordingly, a need exists for improved protective devices for pets to wear, which are designed to prevent the pet from biting, licking or otherwise irritating a wound located on its body.

### SUMMARY OF THE INVENTION

According to certain preferred embodiments of the present invention, protective devices configured to be located around the neck and head region of a pet are provided, which are capable of preventing the pet from biting, licking, or otherwise irritating a wound located on its body. According to certain embodiments of the present invention, the device has a first open end and a second open end. The first open end is located around the pet's head and exhibits a polygon-shaped peripheral edge (such as, for example, a pentagon-shaped peripheral edge), whereas the second open end is located around the pet's neck and comprises a circular- or oval-shaped peripheral edge. Preferably, the device will be comprised of a clear, or substantially clear, plastic material, such that the pet's peripheral vision is not impeded during use of the device. In addition, the invention provides that the device may comprise a weighted collar at the second open end thereof, which is effective is stabilizing and keeping the device properly oriented on the head of the pet. Alternatively, in certain embodiments, the device of the invention may include one or more loops (or sleeves) located at the second open end thereof, through which a pet collar may be disposed for the purpose of stabilizing and keeping the device properly oriented on the head of the pet.

The foregoing and additional features of the present invention will be further described, in more detail, in the Detailed Description of the Invention set forth below.

### BRIEF DESCRIPTION OF THE FIGURES

FIG. 1 is a drawing of the device described herein positioned on the head of a canine pet.

FIG. 2 is a perspective view of the device of FIG. 1.

FIG. 3 is a front, cross-sectional view of the peripheral edge of the first open end of the device.

FIG. 4 is a front, cross-sectional view of the peripheral edge of the first open end of the device, superimposed over a front, cross-sectional view of a prior art conical-shaped protective device.

FIG. 5 is a topside view of the device in an unclosed and planar state.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

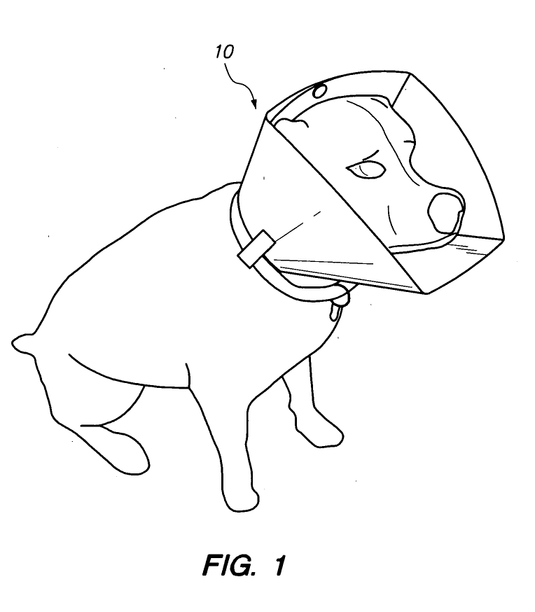

According to certain preferred embodiments of the present invention, protective devices are provided that are positioned around the neck region of a pet. The devices are configured to be effective in preventing the pet from biting, licking or otherwise irritating a wound located on its body. As used herein, the term “pet” includes, but is not limited to, canines, felines, and other four-legged mammals. Referring to FIG. 1, the devices of the present invention are configured to be reversibly positioned over the head of the pet, whereby the device will serve as a barrier to the pet being able to turn its head and neck and disturb a wound located on its body.

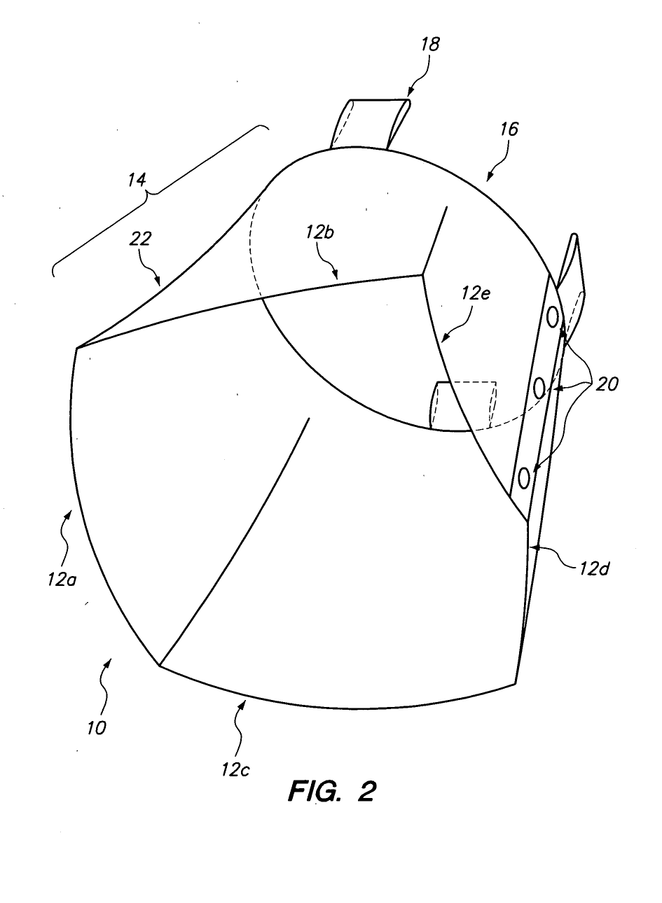

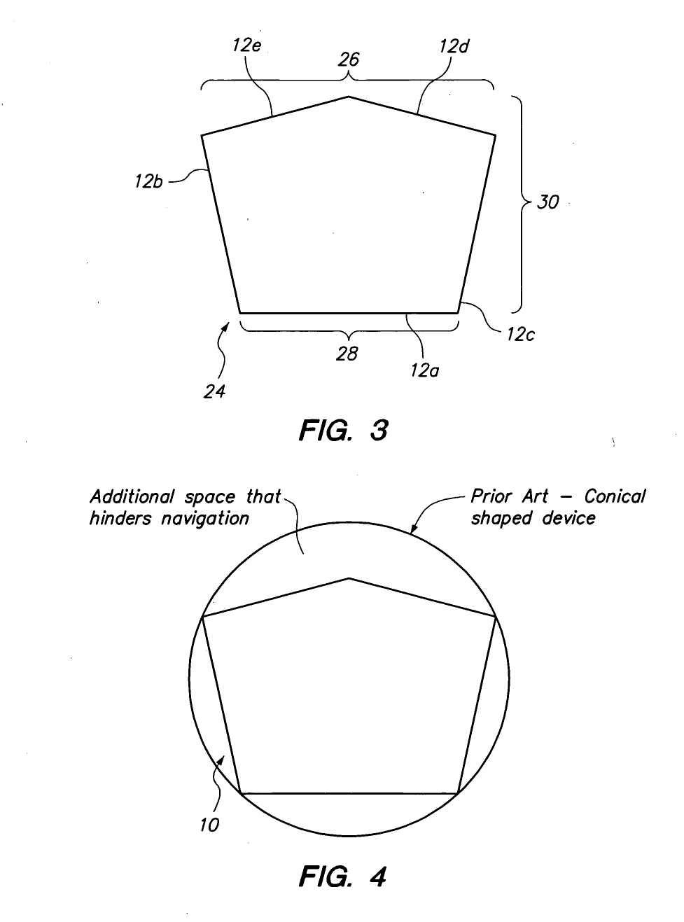

Referring to FIG. 2, the invention provides that the device 10 will preferably comprise a polygonal cross-section, such that the device 10 may comprise, for example, five separate sides, namely, 12a, 12b, 12c, 12d, and 12e. The device 10 further comprises a first open end (adjacent to the pet's head) and a second open end (which encapsulates the pet's neck region). The first open end will have a polygonal-shaped peripheral edge 12, which may exhibit, for example, a pentagon-shaped cross-section. The second open end (which encapsulates the pet's neck region) comprises a circular- or oval-shaped peripheral edge 16. As used herein, the term “polygonal-shaped cross-section,” and similar phrases, means that the cross-section of the first open end will have a series of contiguously-connected sides, as shown in FIG. 3, with a true corner 24 formed between each side. In addition, the invention will encompass a device having a cross-section of the first open end which includes rounded corners.

Referring again to FIG. 2, the invention provides that each of the four sides of the device 10 will have a length 14 that spans from the peripheral edge of the first open end 12 to the peripheral edge of the second open end 16. Preferably, the length 14 of the device is configured to run from the neck region of the pet to the end (or the approximate end) of the pet's face—or even some distance past the pet's face. The invention provides that the sides of the device 10 comprise a crease 22 along the corners thereof, which facilitate folding and closing of the device, as described further below. In certain embodiments, the invention provides that the creases 22 begin at and are perpendicular to the peripheral edge of the first open end 12, and terminate prior to reaching the peripheral edge of the second open end 16. According to such design, the creases 22 encourage a device, when folded and closed, having a polygonal-shaped first open end 12 (such as a pentagon-shaped first open end 12) and a circular- or oval-shaped second open end 16.

In certain embodiments, the ends of the separate sides of the device 10, such as sides 12a, 12b, 12c, 12d, and 12e, exhibit rounded (or arched) edges, with the arched edge running from corner-to-corner (crease-to-crease 22). As explained below, in certain embodiments, the device may initially be in the form of a planar sheet of material (FIG. 5) exhibiting a crescent-like shape. When the device is closed to create a polygonal-shaped (pentagon-shaped) device, the edges of each side 12a, 12b, 12c, 12d, and 12e will be slightly rounded (or arched). The rounded edges may, optionally, be trimmed away from the device, thereby leaving a straight edge from corner-to-corner (crease-to-crease 22). More preferably, however, the invention provides that the rounded edges are not trimmed away, because the rounded edges have been shown to deflect objects more efficiently than a straight edge.

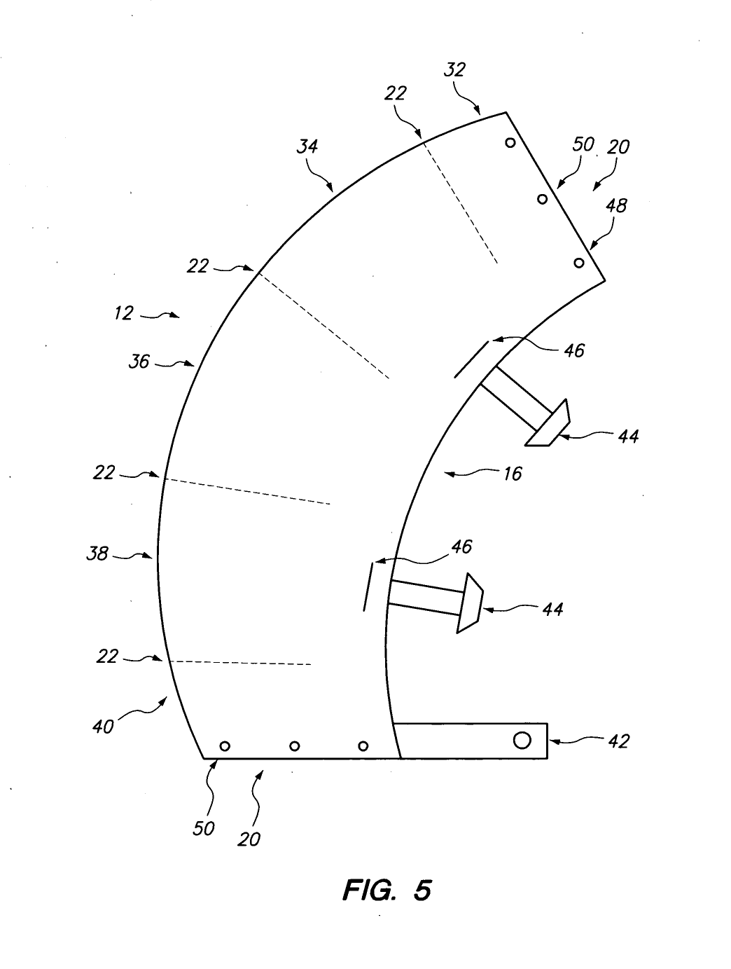

The invention provides that the polygonal-shaped first open end 12 of the device 10 is significantly less wieldy and obtrusive than the prior art conical-shaped devices. Such design results in the pet being able to better navigate a house without “bumping into” furniture or other items. Referring to FIG. 4, for example, if the cross-section of the device 10 of the present invention is compared to that of a prior art conical-shaped device, it will be appreciated that the device 10 of the present invention will take up less space than prior art conical-shaped devices, resulting in an improved ability to navigate throughout a household. In addition, because the second open end 16 exhibits a circular- or oval-shaped cross-section, the device 10 will still fit snuggly (and comfortably) around the neck region of a pet.

The invention provides that all sides of the device 10 may be integrally and contiguously formed with each other. Alternatively, the invention provides that the device 10 may consist of a single planar sheet of material, which may then be closed to achieve the polygonal-sided device 10. For example, the device 10 may include a means for reversibly attaching a first side 12e to a second side 12d in order to close the device 10, such that the device comprises multiple, such as five, contiguously-connected sides when closed. Referring to FIGS. 2 and 5, the device may include a series of snaps 20 that may be used to mechanically and reversibly attach a first side 12e to a second side 12d in order to close the device 10. Additional means for mechanically and reversibly attaching a first side of the device to a second side thereof include, but are not limited to, tabs, buckles, screws, clasps, straps, fabric hook-and-loop fasteners (Velcro®), or combinations thereof.

The invention provides that, in certain embodiments, the device 10 is comprised of a clear plastic material. More particularly, in certain embodiments, the sides 12a, 12b, 12c, 12d, and 12e of the device 10 are comprised of a clear plastic material. According to such embodiments, when a pet is wearing the device 10, the pet's peripheral vision will not be impeded, insofar as the material will preferably be clear. As used herein, the term “clear” means that a pet will be able to view large objects through the device 10 when positioned around its head, although the transparency must not be 100%. In other words, the term “clear” encompasses substantial transparency such that a pet is able to view large objects (albeit not necessarily with 100% resolution). In other embodiments, however, the clear plastic material will be substantially or fully transparent.

The invention provides that any number of plastic materials may be used to achieve a substantially clear device 10, which include polystyrenes, polypropylenes, or other plastics. In certain preferred embodiments, the device 10 is comprised of a clear polycarbonate plastic (or a derivative thereof). The clear polycarbonate plastic may, optionally, be produced from recycled or post-consumer material. The device 10 should exhibit a thickness that is sturdy, yet light and comfortable for the pet to wear. For example, a device 10 comprised of clear polycarbonate plastic may exhibit a thickness ranging between 0.1 to 0.01 inches or, preferably, between 0.05 and 0.01 inches, such as 0.03 inches thick.

According to certain embodiments of the present invention, the device 10 may further comprise one or more sleeves in which a pet collar may be disposed. The sleeve will, preferably, be located along (or close to) the peripheral edge of the second open end 16. In certain embodiments, the device 10 will comprise two or more sleeves 18 in which a pet collar may be disposed, which will serve to hold the device around the neck of the pet, and to properly orient the device. Still further, in certain alternative embodiments, the device 10 may comprises a pet collar that is integrally-formed with the peripheral edge of the second open side of the device 16, such that a separate pet collar is not required. According to such design, additional weighting elements may be added to the pet collar, such as weighting elements that, collectively, add between 0.25 to 1.5 ounces or, more preferably, between 0.50 to 1.25 ounces, such as between 0.75 to 1.0 ounces to the pet collar.

The invention provides that the device 10 may comprise a polygonal-shaped peripheral edge of the first open end 12, such as a pentagon-shaped peripheral edge having five sides. In certain embodiments, each of the five sides may be of equal length. More preferably, however, in certain embodiments, and referring to FIG. 3, the pentagon-shaped peripheral edge of the first open end 12 comprises two sides 12b and 12c of a first length, two sides 12e and 12d of a second length, and a fifth side 12a of a third length. In the configuration shown in FIG. 3, the two sides 12e and 12d exhibit a combined length 26 that is larger than the length 28 of the fifth side 12a. The invention further provides that the polygonal-shaped peripheral edge of the first open end 12 comprises a perimeter ranging between 20 and 60 inches or, preferably, between 30 and 50 inches or, more preferably, between 35 and 45 inches.

Referring now to FIG. 5, as described above, the device 10 may consist of a single planar sheet of material, which may then be closed to achieve the polygonal-sided device, such as the pentagon-shaped device shown in FIGS. 1-3. In certain preferred embodiments, the device 10 will comprise four creases 22, which separate five sections of the device 10, namely, sections 32, 34, 36, 38, and 40 of the device shown in FIG. 5. As shown therein, and as described above, the creases 22 will preferably begin at (and will be perpendicular with) the peripheral edge of the first open end 12, and terminate prior to reaching the peripheral edge of the second open end 16. The invention provides that, when in a single planar sheet, the device 10 exhibits a crescent-like shape. More particularly, referring to FIG. 5, the width of the ends 50 will be less, such as 10%, 20%, or more than 30% less, than the width of the device 10 in its approximate middle, such as the middle of section 36.

As explained above, a series of mechanical connecting means, such as snaps 20, may be located on or near the edge of sections 32 and 40, such that these sections may be reversibly attached to each other to create a five-sided closed device 10, as shown in FIG. 2. In addition, the device 10 may include a strap 42 having a hole located at its distal end, which may be inserted between a set of snaps 48 of sections 32 and 40, such that when these sections are closed, the strap 42 forms a loop through which a pet collar may be disposed.

The device 10 may also include two or more additional strips 44, which are located approximately perpendicular to the peripheral edge of the second open end 16. In such embodiments, the strips 44 may be reversibly folded on themselves and the distal portion thereof may be inserted into a slit (or opening) 46 in the device 10, such that the folded strips 44 form additional sleeves through which a pet collar may be disposed and used to secure the device 10 to the neck region of the pet. The distal end of each strip 44 may include, for example, a piece that is slightly larger than the slit (or opening) 46 in the device 10, such that such distal portion of the strip 44 may be contorted and pushed through the slit (or opening) 46 with some force, but will not easily be involuntarily pulled back out of the slit (or opening) 46. Such design has been shown to provide a suitable sleeve through which a pet collar may be disposed as described herein.

According to certain additional embodiments, the invention encompasses methods of preventing a pet from licking, biting, or otherwise irritating a wound located on its body. Such embodiments generally comprise positioning (and fastening) a device 10 of the present invention over the pet's head as described herein.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A protective device that is configured to be located around a neck region of a pet, which comprises a device having five contiguously connected sides, a first open end and a second open end, wherein (a) the first open end is configured to be positioned around a pet's head and comprises a pentagon-shaped peripheral edge and (b) the second open end is configured to be positioned around the pet's neck and comprises a circular or oval shaped peripheral edge.

2. The device of claim 1, wherein each of the five contiguously connected sides has a length that spans from the peripheral edge of the first open end to the peripheral edge of the second open end, wherein each of the five contiguously connected sides comprises a crease to facilitate folding and closing of the device.

3. The device of claim 2, wherein each crease (a) begins at and is perpendicular with the first open end and (b) terminates prior to the second open end.

4. The device of claim 3, which further comprises a means for reversibly attaching a first side of the device to a second side in order to close the device, such that the device comprises the five contiguously connected sides when closed.

5. The device of claim 4, wherein the means comprises mechanical snaps, tabs, buckles, screws, clasps, straps, fabric hook-and-loop fasteners, or combinations thereof.

6. The device of claim 4, wherein the device is comprised of a clear plastic material.

7. The device of claim 6, wherein the device is comprised of a clear polycarbonate plastic.

8. The device of claim 7, wherein the clear polycarbonate plastic is produced from recycled material.

9. The device of claim 6, which further comprises one or more sleeves located at the second open end in which a pet collar may be disposed.

10. The device of claim 9, which comprises at least two sleeves in which a pet collar may be disposed.

11. The device of claim 6, which further comprises a pet collar that is integrally-formed with the second open side of the device.

12. The device of claim 11, wherein the integrally-formed collar comprises weighting elements that collectively weigh between 0.25 to 1.5 ounces.

13. The device of claim 12, wherein the weighting elements collectively weigh between 0.50 to 1.25 ounces.

14. The device of claim 13, wherein the weighting elements collectively weigh between 0.75 to 1.0 ounces.

15. The device of claim 6, wherein each side of the peripheral edge of the first open end is rounded.

16. The device of claim 15, wherein a cross-section of the peripheral edge of the first open end comprises two sides of a first length, two sides of a second length, and a fifth side of a third length.

17. The device of claim 6, wherein the peripheral edge of the first open end comprises a perimeter ranging between 20 and 60 inches.

18. The device of claim 6, wherein the peripheral edge of the first open end comprises a perimeter ranging between 30 and 50 inches.

19. The device of claim 6, wherein the peripheral edge of the first open end comprises a perimeter ranging between 35 and 45 inches.

20. A protective device that is configured to be located around a neck region of a pet, which comprises a device having five contiguously connected sides, a first open end, a second open end, and one or more sleeves located at the second open end in which a pet collar may be disposed, wherein:
(a) the first open end is configured to be positioned around a pet's head and comprises a pentagon-shaped peripheral edge;
(b) the second open end is configured to be positioned around a pet's neck and comprises a circular or oval shaped peripheral edge;
(c) the device is comprised of a clear polycarbonate plastic;
(d) each of the five contiguously connected sides has a length that spans from the peripheral edge of the first open end to the peripheral edge of the second open end, wherein each of the five sides comprises a crease to facilitate folding and closing of the device, wherein the crease (i) begins at and is perpendicular with the first open end and (ii) terminates prior to the second open end; and
(e) the pentagon-shaped peripheral edge of the first open end comprises two sides of a first length, two sides of a second length, and a fifth side of a third length.
